(19) United States
(12) Patent Application Publication
(10) Pub. No.: US 2022/0115793 A1
(43) Pub. Date: Apr. 14, 2022

(54) GROUND TERMINAL AND WIRE HARNESS

(71) Applicant: SUMITOMO WIRING SYSTEMS, LTD., Mie (JP)

(72) Inventors: Kazuhiro KITAMURA, Mie (JP); Masayoshi TAKATSU, Mie (JP); Koichiro MOCHIZUKI, Mie (JP)

(21) Appl. No.: 17/427,738

(22) PCT Filed: Jul. 29, 2019
(86) PCT No.: PCT/JP2019/029649

§ 371 Date: Aug. 2, 2021

(30) Foreign Application Priority Data
Feb. 14, 2019 (JP) 2019-024711

(51) Int. Cl. H01R 4/72; H01R 4/18; H01R 4/64; H01R 13/03

(52) U.S. Cl. CPC H01R 4/72; H01R 4/185; H01R 2201/26; H01R 13/03; H01R 4/64

(57) ABSTRACT

The present invention provides an earth terminal which is provided with a water sealant layer on a connecting part connected to a wire, the earth terminal being provided with a structure that can suppress the occurrence of the floating of a seating surface of the earth terminal during an earth connection, the floating of the seating surface being caused by a water sealant hanging down in the earth terminal whereby the earth terminal exhibits superior effects in terms of space-saving and cost suppression. The present invention also provides a wire harness provided with the earth terminal. This earth terminal 1 is provided with a terminal fixture 10 having a crimping part 11 for crimping and fixing a wire 40, and a fastening part 15 connected to the earth surface by a fastening member, the terminal fixture 10 being provided with a step having a height D of 2.88 mm to 7.0 mm inclusive between the crimping part 11 and the fastening part 15, wherein a water sealing layer 20 covers at least the crimping part 11 of the terminal fixture 10 and comprises a water sealant for water sealing the wire 40. This wire harness 2 has the earth terminal 1 and the wire 40, wherein an end part of the wire 40 is crimped and fastened by the crimping part 11 of the earth terminal 1 and is covered with the water sealing layer 20.

### TECHNICAL FIELD

The present disclosure relates to a ground terminal and a wire harness.

### BACKGROUND

Some wire harnesses used in vehicles such as automobiles have a ground terminal that is connected to a ground surface such as a vehicle body panel or the like. It is required to suppress water from coming into contact with the ground terminal and penetrating into a wire to which the ground terminal is connected when a vehicle is pressure-washed or the like. As one of methods for this, as disclosed in Patent Document 1 for example, a water splash prevention part may be attached to the ground terminal.

However, there are cases in which a water splash prevention part cannot sufficiently prevent water from coming into contact with the ground terminal, and a water blocking structure for suppressing water from entering the wire in a case in which such water comes in contact with the ground terminal may be provided at a connection portion between the ground terminal and the wire. Examples of such a water blocking structure include a mode in which a connection portion between the ground terminal and the wire is covered with a layer of a water blocking agent formed by an adhesive or the like.

### PRIOR ART DOCUMENT

### Patent Document

Patent Document 1: JP 2007-299650A

### SUMMARY OF THE INVENTION

### Problems to be Solved

When providing a layer of a water blocking agent at the connection portion between the ground terminal and the wire, a method is used in which the water blocking agent is arranged at a predetermined location in a state in which the fluidity has been increased by melting or the like, and solidified. For example, by using a thermoplastic agent as the water blocking agent, applying the water blocking agent that has been melted by heat to a predetermined location and solidifying the water blocking agent, a layer of the water blocking agent that is in intimate contact with the ground terminal and the wire can be formed.

However, there is a possibility that the water blocking agent in which the fluidity has been increased by way of melting or the like will hang down due to gravity before solidifying, and run out to a fastening portion (portion to be fixed to the ground surface by a fastening member such as a bolt) on the leading end side of the ground terminal. The water blocking agent will then solidify in such a state of hanging down. In such a case, when the fastening portion is connected to the ground surface using the fastening member, the water blocking agent hanging down and solidified may prevent the fastening from being reliably performed in a state in which the fastening portion is brought into planar contact with the ground surface, which results in the seating surface of the ground terminal lifting up. The ground terminal shown in Patent Document 1 is a general-purpose ground terminal in which an electric contact portion (fastening portion) at the leading end and a wire connection portion for crimping a wire are planarly continuous with each other. With this planar ground terminal, when a water blocking agent that has been melted is arranged at the wire connection portion, the water blocking agent hangs down, and the seating surface is likely to lift up when connected to the ground.

In view of this, it is desired to provide a structure at the ground terminal for suppressing the seating surface of the ground terminal from lifting up due to the water blocking agent that is hanging down. In terms of reducing the space occupied by the ground terminal inside the vehicle and suppressing material costs required for manufacturing the ground terminal, it is not preferable to use an excessively large or complex structure for suppressing the seating surface from lifting up.

In view of this, an object is to provide a ground terminal provided with a structure that can suppress the seating surface of a ground terminal provided with a layer of a water blocking agent at a connection portion between the ground terminal and a wire from lifting up when grounded due to water blocking agent hanging down and excellent in space-saving and cost reduction effect as well, and a wire harness provided with such a ground terminal.

### Means to Solve the Problem

A ground terminal according to the present disclosure includes a terminal fitting having a crimping portion for crimping and fixing a wire and a fastening portion to be connected to a ground surface by a fastening member, and in which a level difference having a height of at least 2.88 mm and at most 7.0 mm is provided between the crimping portion and the fastening portion, and a water blocking layer that is formed by a water blocking agent for water blocking the wire is provided to cover at least the crimping portion of the terminal fitting.

A wire harness according to the present disclosure includes the above-described ground terminal, and a wire, and an end portion of the wire is crimped and fixed by the crimping portion of the ground terminal and covered with the water blocking layer.

### Effect of the Invention

A ground terminal according to the present disclosure is provided with a structure that can suppress the seating surface of a ground terminal that includes a layer of a water blocking agent at a connection portion between the ground terminal and the wire from lifting up due to water blocking agent handing down when connected to the ground, and excellent in space-saving and cost reduction effect as well. Also, the wire harness according to the present disclosure is a wire harness provided with such a ground terminal.

### BRIEF DESCRIPTION OF THE DRAWINGS

FIG. 1A and FIG. 1B are diagrams showing a structure of the vicinity of an end portion of a wire harness provided with a ground terminal according to an embodiment of the present disclosure. FIG. 1A is a transparent side view and FIG. 1B is a transparent plan view.

FIG. 2A and FIG. 2B are diagrams showing a terminal fitting of the ground terminal. FIG. 2A is a side view and FIG. 2B is a plan view.

FIG. 3 is a side view showing a state in which a wire has been connected to a terminal fitting according to another example.

FIG. 4 is a perspective view showing a heat shrinkable tube that is to be arranged at the ground terminal.

### DETAILED DESCRIPTION TO EXECUTE THE INVENTION

### Description of Embodiments of Disclosure

First, embodiments of the present disclosure will be listed and illustrated.

A ground terminal according to the present disclosure includes a terminal fitting having a crimping portion for crimping and fixing a wire and a fastening portion to be connected to a ground surface by a fastening member, and in which a level difference having a height of at least 2.88 mm and at most 7.0 mm is provided between the crimping portion and the fastening portion, and a water blocking layer that is formed by a water blocking agent for water blocking the wire is provided to cover at least the crimping portion of the terminal fitting.

In the above-described ground terminal, a level difference is provided between the crimping portion and the fastening portion of the terminal fitting, and the height of the level difference is 2.88 mm or more. For this reason, even if the water blocking agent that covers the crimping portion hangs down, the water blocking agent is unlikely to reach the height position of the fastening portion. Therefore, when connecting the fastening portion to the ground surface, the seating surface of the ground terminal is unlikely to lift up due to presence of the water blocking agent that is hanging down. As a result, the fastening portion can be brought into planar contact with and connect to the ground surface, thus making it possible to improve reliability of the ground connection. On the other hand, since the height of the level difference is restricted to 7.0 mm or less, the height of the entirety of the ground terminal is not excessively large, and accordingly, the ground terminal is excellent in space-saving. Also, the amount of materials required for forming the level difference can also be suppressed, thus making it possible to suppress the manufacturing cost of the ground terminal.

Here, a distance between the crimping portion and the level difference may be 10 mm or more. Accordingly, the distance between the crimping portion and the level difference is secured, and thus the leading end portion of the wire conductor protruding forward from the crimping portion can be sufficiently covered with the water blocking agent, and due to the water blocking layer, high water blocking performance can be exhibited with respect to the wire.

The ground terminal may include a coating layer that covers at least the crimping portion and is formed by a heat shrinkable tube being heat shrunk, and the water blocking layer may be arranged in an inner circumferential portion of the coating layer. Accordingly, due to the heat shrinkable tube provided with a layer of water blocking agent at the inner circumferential portion thereof being arranged at the outer circumference of the crimping portion and heat shrunk, the water blocking layer and the coating layer can be readily formed at the entire circumference of the crimping portion. Accompanying the heat-shrinkage of the heat-shrinkable tube, the water blocking agent that cannot remain inside the heat shrinkable tube is extruded outward of the heat shrinkable tube. However, even if the extruded water blocking agent hangs down, since the level difference of a predetermined height is provided between the crimping portion and the fastening portion, the hanging down is not likely to result in the seating surface of the ground terminal lifting up.

In this case, the amount of the water blocking agent may be, in a thickness in a state of being housed in the inner circumferential portion of the coating layer, at least 0.5 mm and at most 1.5 mm. Accordingly, the water blocking agent of an amount sufficient to water-block the wire can be readily arranged at the crimping portion. On the other hand, it is possible to suppress a case in which the excessive amount of water blocking agent is extruded outside when the heat shrinkable tube shrinks.

The heat shrinkable tube may contain cross-linked polyolefin. Accordingly, the heat shrinkable tube is excellent in heat-shrinkability.

The coating layer may be formed by the heat shrinkable tube being heat shrunk at a shrinkage ratio of at least 1% and at most 30%. Accordingly, the heat shrinkable tube can be brought into intimate contact with the crimping portion via the water blocking agent, and a coating layer that exhibits high protection performance with respect to the water blocking layer and the crimping portion can be formed. On the other hand, it is possible to suppress a case in which the heat shrinkable tube excessively shrinks and extrudes a large amount of water blocking agent when shrinking.

The width of the terminal fitting where the crimping portion and the fastening portion intersect each other in a direction of being continuous with each other via the level difference may be at least 5.0 mm and at most 9.0 mm Favorably, a conductor cross sectional area of the wire is at least 2 mm2 and at most 20 mm2 in a nominal conductor cross sectional area. Favorably, the thickness of a metal material constituting the terminal fitting is at least 0.5 mm and at most 3.0 mm In these cases, due to the terminal fitting being designed such that a level difference having a height of at least 2.88 mm and at most 7.0 mm is provided between the crimping portion and the fastening portion, it is possible to effectively suppress the seating surface of the ground terminal from lifting up due to the water blocking agent arranged at the crimping portion hanging down, and readily achieve a ground terminal that is excellent in space-saving and cost-reduction effect.

The water blocking agent may be formed by a hotmelt adhesive. Accordingly, the water blocking agent that has been melted by being heated is arranged in the region including the crimping portion and solidified by cooling, and thus a water blocking layer exhibiting a high water blocking performance can be readily formed. In particular, in the case in which a hotmelt adhesive is arranged at the inner circumferential portion of the heat shrinkable tube, it is possible, by heating, to simultaneously form the coating layer by heat shrinkage of the heat shrinkable tube and the water blocking layer by melting of the hotmelt adhesive.

The terminal fitting may be formed by a metal material including a tinned layer on the surface thereof. Accordingly, it is possible to form the terminal fitting using a material generally used for an electric connection terminal.

The terminal fitting may be provided with only one fastening portion. Accordingly, a ground terminal that is particularly excellent in space-saving and cost reduction can be achieved.

The level difference may be provided such that the fastening portion is located on the lower side with respect to the crimping portion. In this case, the direction in which the water blocking agent arranged at the outer circumference of the crimping portion hangs down due to gravity is the direction in which the fastening member is arranged with respect to the crimping portion. However, since the level difference having a predetermined height is provided between the crimping portion and the fastening portion, the water blocking agent that is hanging down is unlikely to cause the seating surface of the ground terminal to lift up.

The ground terminal may be used in an automobile. Accordingly, even in the case in which water adheres to the terminal fitting due to pressure-washing of the automobile or the like, since the water blocking layer is provided, it is possible to effectively suppress the water from entering inside the wire. Since the level difference between the fastening portion and the crimping portion suppresses the seating surface of the ground terminal from lifting up, it is possible to perform ground connection to a vehicle body panel and the like with high reliability.

The ground terminal may be used without stacking the fastening portions of a plurality of the ground terminals. Accordingly, in addition to the effect that the seating surface of the ground terminal can be suppressed from lifting up due to the level difference between the fastening portion and the crimping portion, it is particularly possible to improve stability of fastening of the ground terminal at the fastening portion.

A wire harness according to the present disclosure includes the ground terminal as described above, and a wire, and an end portion of the wire is crimped and fixed by the crimping portion of the ground terminal and covered with the water blocking layer.

Since the above-described wire harness is provided with a ground terminal such as described above at the end portion of the wire, water is suppressed from entering into the wire due to the water blocking layer provided at the crimping portion of the terminal fitting. Furthermore, due to the level difference of a predetermined height being provided between the crimping portion and the fastening portion, it is possible to suppress the seating surface of the ground terminal from lifting up when connecting the fastening portion to the ground surface, due to the influence of hanging down of the water blocking agent. Also, a wire harness that is excellent in space-saving property of the end portion and cost reduction effect can be achieved.

Here, the wire may be in a single-wire state, or a plurality of the wires may be crimped by the crimping portion which is common thereto. In either of these cases, it is possible to prevent water from entering inside the wires by the water blocking agent arranged at the crimping portion.

### Description of Embodiment of Disclosure

Hereinafter, an embodiment of the present disclosure will be described using the drawings. Note that in all the drawings, the same constituent elements are given the same reference numerals, and the description will be omitted as appropriate.

Details of a ground terminal and a wire harness according to an embodiment of the present disclosure will be described with reference to the drawings. A wire harness according to an embodiment of the present disclosure is formed by connecting the ground terminal according to the embodiment of the present disclosure to an end portion of a wire.

The ground terminal according to the present embodiment includes a terminal fitting having a crimping portion for crimping and fixing a wire and a fastening portion to be connected to a ground surface by a fastening member, and in which a level difference having a height of at least 2.88 mm and at most 7.0 mm is provided between the crimping portion and the fastening portion, and a water blocking layer that is formed by a water blocking agent for water-blocking the wire is provided to cover at least the crimping portion of the terminal fitting.

The inventors of the present application investigated the shape of the level difference of the ground terminal in order to suppress the seating surface of the ground terminal from lifting up. As a result, the inventors found that the seating surface may not be reliably suppressed from lifting up merely by providing the level difference. Although not having been investigated as a design factor of the level difference of the ground terminal, based on that finding, the inventors of the present application tried to design the shape of the level difference of the ground terminal with consideration for the water blocking agent that hangs down when the heat shrinkable tube shrinks. The inventors of the present application actually confirmed the water blocking agent hanging from the heat shrinkable tube, and for the first time, could complete a ground terminal that can suppress the seating surface from lifting up with the minimum size.

<Overview of Ground Terminal and Wire Harness>

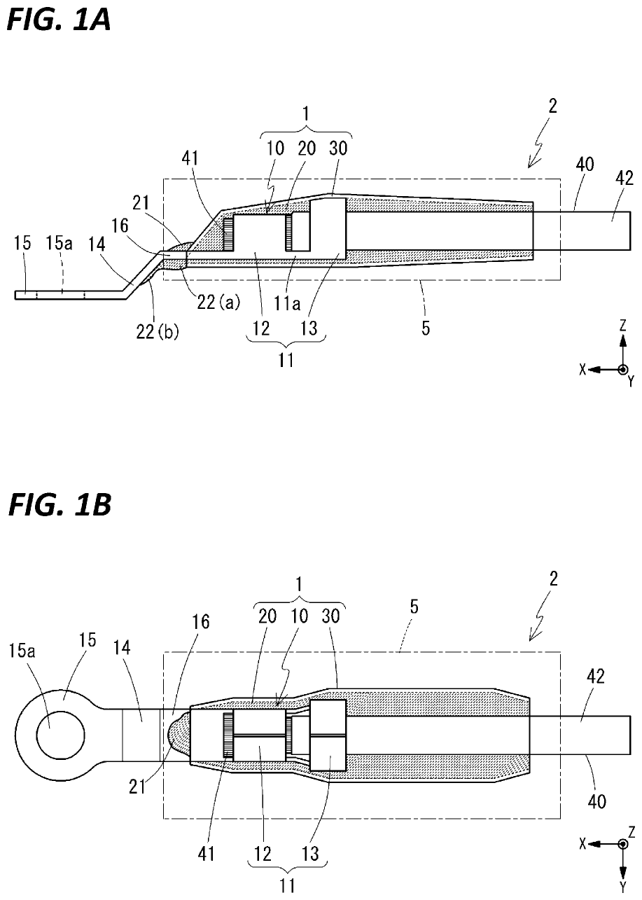

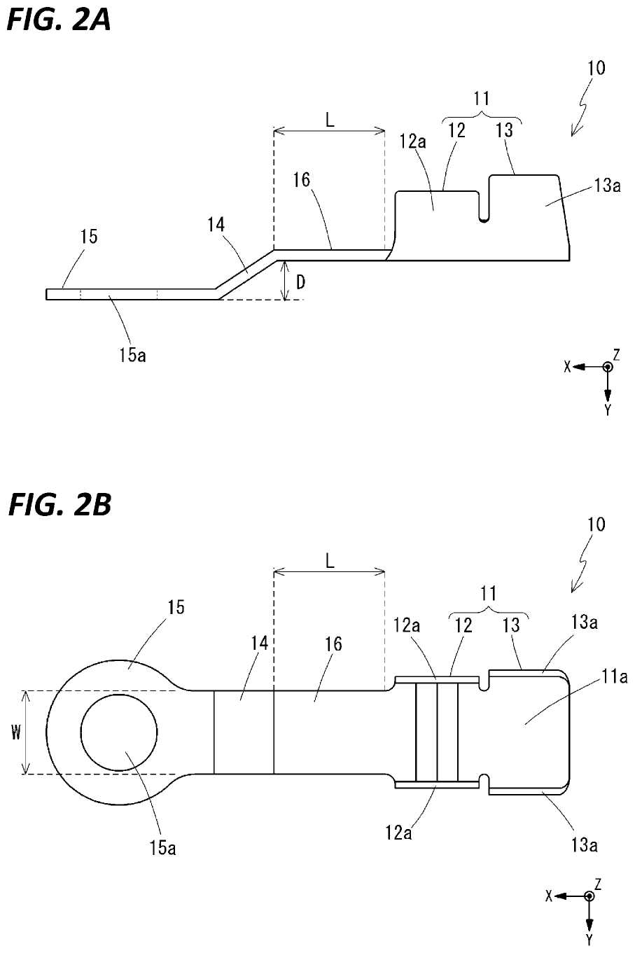

FIGS. 1A and 1B show a schematic structure of a wire harness 2 provided with a ground terminal 1 according to an embodiment of the present disclosure. Also, FIGS. 2A and 2B show a schematic structure of a terminal fitting 10 constituting the ground terminal 1. In the present specification, a longitudinal direction of the ground terminal 1 is a front-rear direction (x direction). The direction in which the ground terminal is connected to the ground surface is frontward (+x direction), and the direction in which a wire 40 is connected is rearward (−x direction). Also, the direction in which the wire 40 is mounted with respect to a bottom surface 11a of the terminal fitting 10 is upward (+z direction), and the direction opposite thereto is downward (−z direction). Furthermore, the direction orthogonal to the front-rear direction (x direction) and the up-down direction (z direction) is the width direction (y direction).

The ground terminal 1 includes the terminal fitting 10, a water blocking layer 20, and a coating layer 30. Also, a wire 40 that constitutes the wire harness 2 together with the ground terminal 1 includes a conductor 41 and an insulating coating 42.

First, the materials constituting the members will be briefly described. The terminal fitting 10 constituting the ground terminal 1 is formed by a metal material. Although the specific material is not particularly limited, a tinned material formed by tinning a metal base material formed by copper or a copper alloy, which is generally used for a material constituting an electric connection terminal, can be illustrated as an example of favorable materials.

The water blocking layer 20 is formed by a water blocking agent that can water-block the wire 40 by covering the leading end portion of the wire 40, that is, a material that can prevent water from entering inside the wire 40. Various kinds of polymer materials may be used as a water blocking agent constituting the water blocking layer 20. In particular, an adhesive including thermoplastic resin, thermosetting resin, ultraviolet curable resin, moisture curable resin, or the like may be favorably used as water blocking agent. Of these, in particular, a hot melt adhesive, which is one type of adhesive including thermoplastic resin may be favorably used.

The coating layer 30 may be formed by any material as long as the water blocking layer 20 and the crimping portion of the terminal fitting 10 can be physically protected, but is preferably formed by a polymer material. Examples of polymer material include rubber, polyolefin, polyvinyl chloride (PVC), and thermoplastic elastomer. As will be described in detail later, in terms of readily forming the coating layer 30 and the water blocking layer 20 using the heat shrinkable tube 5 with water blocking agent, the coating layer 30 is preferably formed by a heat-shrinkable polymer material. In particular, the coating layer 30 is preferably formed by a material including cross-linked polyolefin, which is a polymer that exhibits excellent heat-shrinkability. Note that in the present specification, “polymer material” means a material that contains polymer as the main component, that is, a material in which polymer accounts for 50 mass % or more of all the components.

The conductor 41 constituting the wire 40 is formed by a plurality of metal strands. The plurality of metal strands may be bundled or twisted together. Examples of materials of the metal strands include copper, a copper alloy, aluminum, and an aluminum alloy. The insulating coating 42 is formed by a layer of an insulative polymer covering the outer circumference of the conductor 41. Examples of constituting materials of the insulating coating 42 include rubber, polyolefin, PVC, and thermoplastic elastomer.

Next, the structure of the terminal fitting 10 will be described. The terminal fitting 10 includes a crimping portion 11, an inclined portion 14, and a fastening portion 15, in the order from the rear side. The entirety of the terminal fitting 10 is formed in one piece, and the crimping portion 11 and the fastening portion 15 are integrally continuous via the inclined portion 14 interposed therebetween.

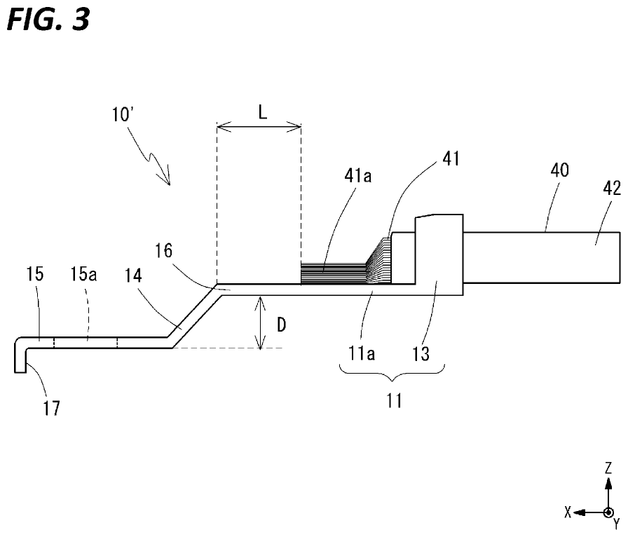

The crimping portion 11 is a portion that crimps and fixes the wire 40 to the terminal fitting 10. The crimping portion 11 includes a first crimping portion 12 and a second crimping portion 13. As shown in FIGS. 2A and 2B, the first crimping portion 12 is provided on the front side and the second crimping portion 13 is provided on the rear side, and the two portions are continuous with each other via a common bottom surface 11a. Also, the first crimping portion 12 and the second crimping portion 13 respectively include a first crimping piece 12a and a second crimping piece 13a that respectively extend outward from the two sides in the width direction of the bottom surface 11a. The bottom surface 11a extends forward from the location at which the first crimping piece 12a is provided, and the portion on the front side of the first crimping portion 12 is a flat portion 16. Note that a mode may also be used in which the crimping portion 11 is not provided with the first crimping portion 12 as in a terminal fitting 10′ shown in FIG. 3, for example. In that case, a portion that has a sufficient length for the conductor 41 of the wire 40 to be welded thereto by ultrasonic welding or the like may be secured on the front side of the second crimping portion 13 as the bottom surface 11a.

The fastening portion 15 is a portion for connecting the terminal fitting 10 to a ground surface (connection surface forming the ground potential). The fastening portion 15 is formed at a location on the lower front side with respect to the crimping portion 11, and a level difference having the height D is provided between the crimping portion 11 and the fastening portion 15. As will be described in detail later, in the present embodiment, the height D of the level difference is defined within a predetermined range.

The fastening portion 15 is formed in a flat plate shape having surfaces which are approximately parallel to the bottom surface 11a of the crimping portion 11. A through hole 15a through which a fastening member such as a bolt can pass is provided in the fastening portion 15. Note that the structure is not limited to the through hole 15a as long as the fastening member can be inserted therethrough, and for example, alternatively, a cutout that opens in the front end edge of the fastening portion 15 may be provided. Also, in terms of securing the strength of the fastening portion 15, a flange (not shown) may be integrally provided standing upright at the end edge of the fastening portion 15.

The inclined portion 14 connects between the front end portion of the flat portion 16 provided on the front side of the crimping portion 11 and the rear end portion of the fastening portion 15. Since the fastening portion 15 is provided on the lower side with respect to the crimping portion 11 and the level difference is formed between the fastening portion 15 and the crimping portion 11, the inclined portion 14 is formed as an inclined surface that inclines downward as the front side is approached from the rear side.

Furthermore, as shown in FIG. 3, the terminal fitting 10 may be provided with a rotation stopper 17 on the front side of the fastening portion. The rotation stopper 17 is integrally formed with the fastening portion 15 and protrudes downward from the front end of the fastening portion. When performing work for inserting the fastening member into the through hole 15a of the fastening portion 15 and connecting the terminal fitting 10 to the ground surface, if the rotation stopper 17 is locked to an end edge and a groove-like structure provided on the ground surface, rotation of the ground terminal 10 during the work can be suppressed and workability can be improved.

The terminal fitting 10 having a structure such as described above is connected to the end portion of the wire 40. At the end portion of the wire 40, the insulating coating 42 has been removed and the conductor 41 is exposed. The end portion of the wire 40 is crimped and fixed to the terminal fitting 10 by the crimping portion 11. At this time, the first crimping portion 12 on the front side crimps the exposed conductor 41 and the second crimping portion 13 on the rear side crimps the portion of the conductor 41 covered with the insulating coating 42. In the mode shown in the drawing, the single wire 40 is crimped in a single-wire state, but a plurality of wires 40 may be co-crimped. In the present specification, “co-crimping” means crimping the plurality of wires 40 with the crimping portion 11 of the common terminal fitting 10 in the state of being arranged side by side or stacked. Note that in the case in which the crimping portion 11 is not provided with the first crimping portion 12 as in the terminal fitting 10′ in FIG. 3, a welding portion 41a may be formed by welding the conductor 41 exposed from the insulating coating 42 at a region on the front side of the second crimping portion 13 of the bottom surface 11a by ultrasonic welding or the like. In this case as well, the conductor 41 of a single wire 40 may be welded to the bottom surface 11a at the welding portion 41a in the single-wire state, or the conductors 41 of plurality of wires 40 may be welded to the bottom surface 11a at the common welding portion 41a in the state where the wires 40 are arranged in parallel or stacked. Note that, if the number of wires is two or less, the terminal fitting is preferably provided with the first crimping portion 12, for example. The mode in which the conductor 41 is welded to the bottom surface 11a by ultrasonic welding is preferably used in the case in which the number of wires is more than three and the first crimping portion 12 cannot hold the wires.

The wire 40 is water-blocked at the connection portion between the terminal fitting 10 and the wire 40. In other words, the water blocking layer 20 is provided in the region, of the terminal fitting 10, including the crimping portion 11 that crimps and fixes the wire 40. The water blocking layer 20 may be provided over any range as long as the water blocking layer 20 is formed to at least cover the entire circumference of the crimping portion 11 in the entire region of the crimping portion 11 in the front-rear direction. In the mode shown in the drawings, the water blocking layer 20 is formed around the entire circumference occupying a region spanning from an intermediate portion of the flat portion 16 that corresponds to frontward of the leading end portion of the conductor 41 protruding forward from the crimping portion 11 to an intermediate portion of the wire 40 extending rearward of the crimping portion 11. At the location at which the insulating coating 42 has been removed at the end portion of the wire 40, the water blocking agent constituting the water blocking layer 20 preferably penetrates into a gap between the strands constituting the conductor 41, as well as covering the outer circumference of the conductor 41 and the first crimping portion 12 (the welding portion 41a when using the terminal fitting 10′ that is not provided with the first crimping portion 12).

Note that a configuration is also possible in which solder is arranged the at the outer circumference of the conductor 41 and between the strands constituting the conductor 41, and then the water blocking layer 20 and the coating layer 30 are provided thereon. Due to the solder penetrating between the strands constituting the conductor 41, water blocking performance with respect to the wire 40 can be improved. For example, the conductor 41 may be soldered to the terminal fitting 10 in the surrounding of the first crimping portion 12 (or the welding portion 41a). If soldering is performed at that location, the solder readily penetrates between the strands due to capillary action. At this time, if the solder is arranged not so as to come into contact with the insulating coating 42, melting of the insulating coating 42 due to contact with the solder can be avoided. Note that in the ground terminal 1 according to the present embodiment, even if soldering is not performed, the entirety of the conductor 41 can be covered with the water blocking layer 20. For this reason, the ground terminal 1 according to the present embodiment is preferable in terms of being able to exhibit sufficient water blocking performance

Since the water blocking layer 20 covers the region including the crimping portion 11, the wire 40 can be water-blocked. Specifically, even if water comes in contact with the surface of the ground terminal 1 such as the fastening portion 15 from the outside, it is possible to suppress the water from entering inside the wire 40, that is, the space between the conductor 41 and the insulating coating 42 and the space between the strands constituting the conductor 41.

The coating layer 30 covers the outer circumference of the water blocking layer 20. In the mode shown in the drawings, the water blocking agent constituting the water blocking layer 20 has been filled in the entirety of the inner region of the region covered with the coating layer 30. The coating layer 30 need not necessarily be provided in terms of water blocking of the wire 40, however, if the coating layer 30 is provided, it is possible to physically protect the water blocking layer 20 and the crimping portion 11 of the terminal fitting 10. Furthermore, as will be described later, when forming the water blocking layer 20 using a heat shrinkable tube with water blocking agent, the coating layer 30 can be readily formed simultaneously with the water blocking layer 20.

In order to connect the ground terminal 1 to the end portion of the wire 40 to form the wire harness 2, first, the wire 40 in which the insulating coating 42 at the end portion has been removed is mounted on the upper side of the bottom surface 11a of the crimping portion 11 of the terminal fitting 10. Then, the conductor 41 is crimped so as to be enveloped by the crimping piece 12a of the first crimping portion 12. In the case in which the terminal fitting 10′ that is not provided with the first crimping portion 12 is used, the exposed conductor 41 is welded to the bottom surface 11a on the front side of the second crimping portion 13 by ultrasonic welding or the like. Furthermore, the region of the wire 40 in which the insulating coating 42 is formed is crimped so as to be enveloped by the crimping piece 13a of the second crimping portion 13. In this manner, the wire 40 is fixed and connected to the terminal fitting 10. Thereafter, the conductor 41 may also be welded to the terminal fitting 10. In this manner, the solder penetrates between the strands constituting the conductor 41, thus making it possible to improve water blocking performance with respect to the wire 40. Soldering may be performed at locations of the first crimping portion 12 or the welding portion 41a, or the surrounding area thereof.

Subsequently, a region that spans from a position frontward of the leading end of the conductor 41 to a position rearward of the crimping portion 11 is covered with the water blocking agent to form the water blocking layer 20. At this time, by the water blocking agent in a highly fluid state being arranged at a predetermined region by application or the like and then solidified, the dense water blocking layer 20 can be formed. For example, in the case in which the water blocking agent contains a thermoplastic resin such as a hotmelt adhesive, the water blocking layer 20 can be formed by performing application or the like of the water blocking agent in the state of being melted by heating, and solidifying the water blocking agent by cooling. As shown in FIGS. 1A and 1B, the arrangement of the water blocking agent by application or the like is performed while holding the terminal fitting 10 using a jig or the like as appropriate such that the fastening portion 15 of the terminal fitting 10 is on the lower side and the crimping portion 11 is on the upper side with respect to the gravity direction. While forming the water blocking layer 20, the coating layer 30 may be formed outside of the water blocking layer 20 as necessary.

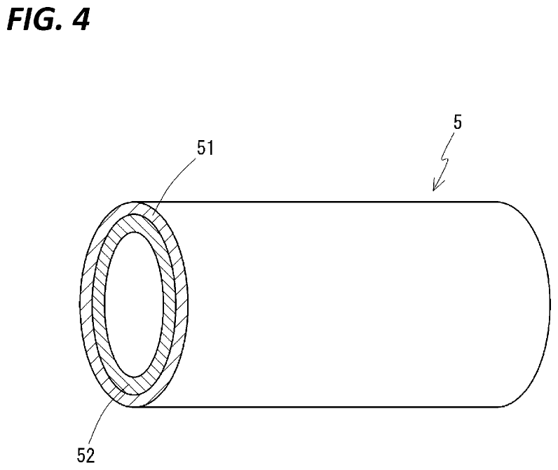

If the heat shrinkable tube 5 with water blocking agent in which a material that can serve as the water blocking agent such as an adhesive is arranged at the inner circumferential portion of a heat shrinkable tube is used, the water blocking layer 20 and the coating layer 30 can be formed simultaneously. FIG. 4 shows an example of the heat shrinkable tube 5 with water blocking agent. An inner layer 52 including a hot-melt adhesive is formed on the inner circumferential surface of the cylindrically-shaped heat shrinkable tube 51 (outer layer) that contains a heat-shrinkable material such as cross-linked polyolefin. As indicated by the dot-and-dash line in FIG. 1A, this heat shrinkable tube 5 with water blocking agent is heated in the state of covering a location including the crimping portion 11 of the terminal fitting 10 to which the wire 40 is connected. Accompanying the heating, the water blocking agent (adhesive) constituting the inner layer 52 melts and comes in close contact with the surfaces of the terminal fitting 10, the conductor 41 exposed from the insulating coating 42, and the insulating coating 42, and the heat shrinkable tube 51 that is the outer layer shrinks by heat. When the heating is stopped and cooling is performed, the water blocking agent solidifies to form the water blocking layer 20. Then, the water blocking layer 20 formed by the water blocking agent solidifying is arranged on the inner circumference of the coating layer 30 formed by the shrunk heat shrinkable tube 51. Note that, in consideration of the length (size in the front-rear direction) of the heat shrinkable tube 51 becoming shorter when shrunk, it is preferable to set the length of the heat shrinkable tube 5 with the water blocking agent that is to be overlaid before shrinkage longer in order for the region that spans from frontward of the leading end of the conductor 41 to rearward of the crimping portion 11 to be covered with the water blocking layer 20 and the coating layer 30 that are formed after heating.

When the heat shrinkable tube 51 shrinks, due to a decrease in volume of the space inside the heat shrinkable tube 51, a portion of the water blocking agent may not remain within the region covered with the coating layer 30 and be extruded outward of the coating layer 30 in some cases. In such a case, an extruded portion 21 may be formed by the extruded water blocking agent solidifying on the front side of the coating layer 30, and a hanging portion 22 may be formed by the extruded water blocking agent hanging downward due to gravity and solidifying. The hanging portion 22 may be formed in the following two ways: the hanging water blocking agent solidifying in a droplet shape below the coating layer 30 or the flat portion 16, as shown in the reference sign 22(a) in FIG. 1A; and the hanging water blocking agent solidifying in the state of running out forward along the lower surface of the inclined portion 14, as shown in the reference sign 22 (b). As will be described below, since the level difference is provided in the terminal fitting 10 of the ground terminal 1 according to the present embodiment, even if the hanging portion 22 is formed, the stability of connection is unlikely to be affected by the hanging portion 22 when connecting the fastening portion 15 of the ground terminal 1 to the ground surface.

The application of the ground terminal 1 and the wire harness 2 according to the present embodiment is not particularly limited, but the ground terminal 1 and the wire harness 2 can be favorably used in vehicles such as automobiles. Due to the water blocking layer 20 being provided in the region of the terminal fitting 10 that includes the crimping portion 11, it is possible to sufficiently suppress water from entering inside the wire 40 when using or washing the vehicle.

<Level Difference of Terminal Fitting and Ground Connection>

As described above, in the ground terminal 1 according to the present embodiment, the level difference is provided between the crimping portion 11 and the fastening portion 15 of the terminal fitting 10. The height D of the level difference, that is, the distance in the up-down direction between the lower end of the bottom surface 11a of the crimping portion 11 and the lower end of the fastening portion 15 is defined within a predetermined range. Specifically, the height D is at least 2.88 mm and at most 7.0 mm

If the level difference is not formed in the terminal fitting 10, or if the height D of the level difference is not sufficiently large, when forming the water blocking layer 20, the water blocking agent in a highly fluid state may not remain at the position at which the water blocking layer 20 is to be formed, and hang down. If the water blocking agent solidifies in that state, the hanging portion 22 thus formed may affect the connection of the terminal fitting 10 at the fastening portion 15. For example, the water blocking agent may hangs down due to gravity, reach a position on the lower side with respect to the height position of the fastening portion 15, and solidify there. Alternatively, the water blocking agent may flow frontward along the metal member constituting the terminal fitting 10, reach the lower end of the fastening portion 15, and solidify in that state. As such, when bringing the lower surface of the fastening member 15 into contact with the ground surface to perform connection, the hanging portion 22 that is generated by the water blocking agent solidifying comes into contact with the ground surface, which inhibits the fastening portion 15 from coming into planar contact with the ground surface. In this state, even if connection is performed using a fastening member such as a bolt, the seating surface of the fastening portion 15 lifts up, and as a result, ground connection cannot be performed stably and with a high reliability. In terms of cost and labor, it is not realistic to remove the hanging portion 22 separately in order to suppress the seating surface from lifting up.

In view of this, by setting the height D of the level difference to 2.88 mm or more, even when the water blocking agent hangs down, it is possible to retain the hanging portion 22 within a location that does not reach the height position of the lower surface of the fastening portion 15. In other words, due to the level difference having a sufficient height being formed between the crimping portion 11 and the fastening portion 15, even if the water blocking agent in a highly fluid state hangs down, the water blocking agent solidifies before reaching the height position of the lower surface of the fastening portion 15, and no longer be able to reach the height position of the fastening portion 15 due to hanging down. Accordingly, the lower surface of the fastening portion 15 is maintained in a flat state, and it is possible to perform fastening with the fastening member in the state in which the fastening portion 15 comes into planar contact with the ground surface without the seating surface lifting up. As a result, ground connection using the ground terminal 1 can be performed stably and with a high reliability. Also, it is not necessary to remove the hanging portion 22 in order to suppress the seating surface from lifting up. The height D of the level difference is, more preferably, 3.00 mm or more.

On the other hand, if the height D of the level difference is set too large, the effect of suppressing the seating surface from lifting up is saturated, and an excessive increase in size of the ground terminal 1 and an increase in the material cost of the terminal fitting 10 are incurred. In view of this, due to the height D of the level difference being set to 7.0 mm or less, it is possible to suppress an increase in the size and cost of the ground terminal 1, and achieve the ground terminal 1 that is excellent in space-saving and cost reduction effect. More preferably, the height D of the level difference is 5.0 mm or less.

Furthermore, the terminal fitting 10 includes the flat portion 16 between the crimping portion 11 and the inclined portion 14. Since the flat portion 16 is provided, it is possible to form the water blocking layer 20 on the front side of the crimping portion 11 with a margin. In the case in which the terminal fitting 10 does not include the flat portion 16, or if the length of the flat portion 16 is too short even when the terminal fitting 10 includes the flat portion 16, a portion on the leading end side of the conductor 41 may be exposed instead of being covered with the water blocking layer 20 and the coating layer 30. In such a case, water may enter through the exposed portion, and sufficient water blocking performance may not be achieved. In view of this, if the flat portion 16 is provided, and further, if the length L of the flat portion 16, that is, the distance between the crimping portion 11 and the level difference is set to 10 mm or more, the leading end portion of the conductor 41 that protrudes forward from the crimping portion 11 can be covered with the water blocking layer 20 and the coating layer 30 with a margin, thus making it possible to effectively suppress water from entering through the leading end portion of the conductor 41. Note that, as shown in FIG. 3, in the case of the terminal fitting 10′ that is not provided with the first crimping portion 12, the length L of the flat portion 16 is defined as the distance between the position that corresponds to the leading end of the welding portion 41a and the level difference.

In particular, in the case in which the water blocking layer 20 and the coating layer 30 are formed by the heat shrinkable tube 5 with water blocking agent, as indicated by a dash-and-dot line in FIG. 1A, the heat shrinkable tube 5 with the water blocking agent, which has been arranged such that the front end edge is located within the flat portion 16, is heat shrunk, thus making it possible to form the water blocking layer 20 and the coating layer 30 with a sufficient length left on the front side of the crimping portion 11. For example, in the case in which the lengths of the water blocking layer 20 and the coating layer 30 that are to be left on the front side of the crimping portion 11 after shrinkage are 5 mm or more, when it is assumed that the heat shrinkage rate (rate of change in length accompanying heat-shrinkage) of the heat shrinkable tube 51 is 10%, and the error in cutting the heat shrinkable tube 5 with the water blocking agent is 1 mm, when the flat portion 16 with the length of 10 mm is provided and the heat shrinkable tube 5 with water blocking agent is arranged to be aligned with the front end edge of the flat portion 16 and heat shrunk, the water blocking layer 20 and the coating layer 30 can be formed from a position 5 mm or more on the front side of the front end of the crimping portion 11 as desired. On the other hand, in terms of space-saving and cost reduction of the ground terminal 1, the length L of the flat portion 16 is preferably 20 mm or less, and more preferably, 15 mm or less.

Note that, when the water blocking layer 20 and the coating layer 30 are formed by the heat shrinkable tube 5 with water blocking agent, as described above, the water blocking agent extruded from the heat shrinkable tube 51 forms an extruded portion 21 on the upper and front side of the crimping portion 11, as well as the hanging portion 22. This extruded portion 21 is preferably formed. This is because, since the extruded portion 21 is formed, it is possible to confirm that the water blocking layer 20 is formed on the front side of the leading end of the conductor 41, and high water blocking performance can be readily achieved.

The sizes of the remaining portions of the terminal fitting 10 are not particularly limited, and may be set as appropriate based on the shape, size, and the like of the terminal fitting that has conventionally been generally used as a ground terminal. For example, based on a conventional general terminal fitting having the sizes as below, the terminal fitting 10 having the similar sizes may be designed. In this case, according to the used amount of water blocking agent assumed from the sizes of the portions of the terminal fitting 10, if the level difference having the height D of at least 2.88 mm and at most 7.0 mm is provided, it is possible to effectively suppress the seating surface of the ground terminal 1 from lifting up due to formation of the hanging portion 22.

Width (W) of the terminal fitting 10: at least 5.0 mm and at most 9.0 mm More preferably, at least 6.0 mm and at most 7.5 mm

Thickness of the metal material constituting the terminal fitting 10: at least 0.5 mm and at most 3.0 mm More preferably, at least 1.0 mm and at most 1.2 mm

Conductor cross-sectional area of the wire 40 to be crimped: Nominal conductor cross sectional area is at least 2 mm² and at most 20 mm². More preferably, at least 4 mm² and at most 10 mm². Note that, when a plurality of the wires 40 are co-crimped, the sum of nominal conductor cross-sectional areas of all the wires 40 are the value of the conductor cross-sectional area.

When the water blocking layer 20 and the coating layer 30 are formed by the heat shrinkable tube 5 with water blocking agent, the amount of the water blocking agent to be used is at least 0.5 mm and at most 1.5 mm when converted to the thickness in the state of being housed in the inner circumferential portion of coating layer 30, that is, the thickness in the state of being housed in the inner circumferential portion of the heat shrinkable tube 51 after shrinkage. Here, the amount of water blocking agent is obtained by converting the sum of the amount of the water blocking agent remaining inside the coating layer 30 and the water blocking agent that is extruded outward of the coating layer 30 to form the extruded portion 21 and the hanging portion 22 after the heat shrinkable tube 51 is shrunk, into the thickness in the state of being arranged at the inner circumferential portion of the coating portion 30. If the amount of water blocking agent is set to 0.5 mm or more in this converted value, the water blocking layer 20 that exhibits a sufficient water blocking performance with respect to the wire 40 can be readily formed. More preferably, the amount of water blocking agent is 0.7 mm or more. On the other hand, if the amount of the water blocking agent is set to 1.5 mm or less in this converted value, the amount of water blocking agent that is extruded from the coating layer 30 and forms the hanging portion 22 when heat shrinking is performed can be suppressed. More preferably, the amount of water blocking agent is 1.0 mm or less. As represented by a volume per the length of 1 mm of the heat shrinkable tube 51 after shrinkage, the amount of water blocking agent is preferably 5 mm³ or more, and more preferably 8 mm³ or more. Also, the amount of water blocking agent is preferably 50 mm³ or less, and more preferably, 25 mm³ or less.

It is preferable that the heat shrinkable tube 51 having the heat shrinkage rate of at least 1% and at most 30% is used, and the heat shrinkable tube 51 is shrunk at such a heat shrinkage rate to form the coating layer 30. Here, “heat shrinkage rate” means the rate of change in length of the heat shrinkable tube 51. That is, when the length of the heat shrinkable tube 51 before shrinkage is A1 and the length of the heat shrinkable tube 51 after being heated at 135° C. and sufficiently shrunk is A2, the heat shrinkage rate is (A1−A2)/A1×100%. If the heat shrinkable tube 51 is shrunk at the heat shrinkage rate of 1% or more to form the coating layer 30, it is possible to favorably bring the coating layer 30 into close contact with the water blocking layer 20, and exhibit high protection performance with respect to the water blocking layer 20 and the portions such as the crimping portion 11 that are covered with the water blocking layer 20. On the other hand, if the heat shrinkage rate is suppressed to be 30% or less, it is possible to readily suppress a case in which an excessive amount of the water blocking agent is extruded by the heat shrinkable tube 51 heat shrunk and forming a hanging portion 22 that hangs downward in an elongated manner

As described above, in the ground terminal 1 according to the present embodiment, since the terminal fitting 10 is provided with the level difference having the height D of at least 2.88 mm and at most 7.0 mm and the water blocking layer 20 is formed at the portion including the crimping portion 11, water blocking performance by the water blocking layer 20 and suppression of lifting up of the seating surface due to hanging down of the water blocking agent can be achieved simultaneously. Also, the ground terminal 1 that is excellent in space-saving and cost reduction effect can be achieved.

Specific sizes, shapes, usages, and the like of the remaining portions of the ground terminal 1 and the wire harness 2 are not particularly limited as long as the terminal fitting 10 is provided with the level difference having the predetermined height D. For example, in the mode described above, the level difference is formed such that the fastening portion 15 is located on the lower side with respect to the crimping portion 11, but the level difference may be formed such that the fastening portion 15 is located higher than the crimping portion 11. Note that, in the case in which the fastening portion 15 is formed on the lower side with respect to the crimping portion 11, hanging down of the water blocking agent due to gravity is more likely to occur in the direction in which the fastening portion 15 is located, and thus the effect of suppressing the seating surface from lifting up due to formation of the level difference is even more beneficial. Also, in the above description, the terminal fitting 10 having only one fastening portion 15 and only one inclined portion 14 is used, however, the terminal fitting 10 may be provided with a plurality of both or either fastening portions 15 and inclined portions 14 that are arranged in the front-rear direction, for example. Having said that, the terminal fitting 10 provided with only one fastening portion 15 and only one inclined portion 14 is more excellent in space-saving and cost reduction effect.

Furthermore, other than the mode in which the fastening portion 15 of one ground terminal 1 is fastened to the ground surface with one fastening member, a usage mode is also conceivable in which the fastening portions 15 of a plurality of ground terminals 1 that are respectively connected to different wires 40 are stacked and fastened to the ground surface with a common fastening member. However, since the stability of fastening is further improved in the mode in which the fastening portion 15 of one ground terminal 1 is individually fastened with one fastening member instead of stacking the fastening portions 15 of a plurality of ground terminals 1, it is possible to more effectively utilize the effect of suppressing the seating surface of the ground terminal 1 from lifting up and improving the stability of fastening due to the level difference being provided in the terminal fitting 10. On the other hand, even in the case in which the plurality of wires 40 are co-crimped with the crimping portion 11 of one terminal fitting 10, if the end portions of the wires 40 are reliably covered with the water blocking layer 20, high water blocking performance and a stable ground connection due to suppressing the seating surface from lifting up with respect to the wires 40 can be achieved. In the case in which the plurality of wires 40 are co-crimped, it is preferable to provide the water blocking layer 20 and the coating layer 30 so as to collectively cover the end portions of all the wires 40.

### Working Examples

Hereinafter, working examples of the present disclosure will be described. The present invention is not limited to the working examples below.

(Production of Samples)

Terminal fittings having a shape shown in FIGS. 2A and 2B were produced with a tinned copper alloy material. At this time, the width W of the terminal fitting was 6.8 mm and the thickness was 1.0 mm For each sample, the height D of the level difference and the length L of the flat portion were set to the values shown in Table 1.

Next, as shown in FIGS. 1A and 1B, the wire in which the insulating coating at the end portion has been removed was crimped and fixed by the crimping portion of the terminal fittings thus produced. As shown in Tables 1 and 2, the number of the connected wires were one (single wire) or two (co-crimping). The nominal conductor cross-sectional areas of the wires are also shown in Tables 1 and 2.

Further, the water blocking layer and the coating layer were formed using the heat shrinkable tube with water blocking agent. As this time, as shown in FIG. 1A, the heat shrinkable tube with water blocking agent was arranged so as to cover the portion spanning from the front end edge of the flat portion of the terminal fitting to the portion on the wire in the rear of the crimping portion. Thereafter, the heat shrinkable tube with water blocking agent was heated at 135° C. to shrink the heat shrinkable tube and melt of the water blocking agent, and wire harnesses were produced as samples A1 to A9 and samples B1 to B4. The heat shrinkable tubes with water blocking agent that were used were as below. All the heat shrinkable tubes contained cross-linked polyethylene as the main component, and had a heat shrinkage rate of 10% or less. The water blocking agent was formed by hotmelt adhesive. Note that, as described above, the shrinkage rate of the heat shrinkable tube indicates the rate of change in length in accordance with heat shrinkage.

SA3-2: “Sumitube SA3-2” manufactured by Sumitomo Electric Fine Polymer Co., Ltd. Adhesive amount: 0.76 mm; 9.6 mm³

SA3-3: “Sumitube SA3-3” manufactured by Sumitomo Electric Fine Polymer Co., Ltd. Adhesive amount: 1.02 mm; 18.6 mm³ In the above description, the value (unit: mm) obtained by converting to the thickness in the state of being housed in the inner circumferential portion of the heat shrinkable tube after shrinkage and the value (unit: mm) obtained by converting to the volume per the length of 1 mm of the heat shrinkable tube after shrinkage are both described as the adhesive amount.

(Evaluation Method)

Lifting of Seating Surface

Whether the seating surface lifted up was evaluated with respect to the samples produced as above. Specifically, the fastening portion of the terminal fitting was fastened and fixed to the ground surface formed in a flat plate using a bolt, and whether the seating surface lifts up was confirmed by visual observation. In the case in which the lower surface of the fastening portion was in planar contact with the ground surface, it was evaluated that the seating surface did not lift up. On the other hand, in the case in which there was a portion that was not in contact with the ground surface and lifted up on the lower surface of the fastening portion, it was evaluated that the seating surface lifted up. With respect to each of the samples, testing was performed on 20 samples (n=20) that were produced in the same manner, and if the seating surfaces of all the samples did not lifting up, it was determined that the seating surface did not lift up (A), and if there was even one sample whose seating surface lifted up, it was determined that the seating surface lifted up (B).

Coating Condition of Leading End Portion of Conductor

Whether the leading end portion of the wire conductor was sufficiently coated with the water blocking layer and the coating layer was visually determined for each sample. In the case in which the wire conductor was not exposed from the front end edge of the water blocking layer and the coating layer and was completely covered with the water blocking layer and the coating layer, it was determined that the coating condition was particularly excellent (A+). In the case in which the leading end of the wire conductor was flush with the front end edge of the coating layer and covered with the water blocking layer, it was determined that the coating condition was good (A). When the tip of the electric wire conductor was exposed frontward of the front edges of the water blocking layer and the coating layer, it was determined that the coating condition was poor (B). For each sample, determination was performed on 20 individuals (n=20) produced in the same manner, and the same coating condition was observed for all the samples.

(Test Results)

Tables 1 and 2 below summarize the configurations of wire harnesses and evaluation results for samples A1 to A9 and samples B1 to B4, respectively.

TABLE 1

| | | | | | | | | | |
|---|---|---|---|---|---|---|---|---|---|
| Sample Number | A1 | A2 | A3 | A4 | A5 | A6 | A7 | A8 | A9 |

| | | | |
|---|---|---|---|
| Terminal | Height of level difference d [mm] | 3.00 | 2.88 |

| fitting | Length of flat portion L [mm] | | 10.0 | | | 10.0 | | | 9.0 | | |
|---|---|---|---|---|---|---|---|---|---|---|---|
| | Single/Co-crimping | | Single | Co-crimp | Single | Co-crimp | Single | Co-crimp | Single | Co-crimp | Single |
| Wire | Nominal conductor | Wire 1 | 5.00 | 2.00 | 8.00 | 5.00 | 5.00 | 2.00 | 8.00 | 5.00 | 5.00 |
| | cross-sectional area | Wire 2 | — | 2.00 | — | 1.25 | — | 2.00 | — | 1.25 | — |
| | [mm²] | | | | | | | | | | |

| | | | | | | | | | |
|---|---|---|---|---|---|---|---|---|---|
| Heat-shrinkable tube | SA3-2 | SA3-2 | SA3-3 | SA3-3 | SA3-2 | SA3-2 | SA3-3 | SA3-3 | SA3-2 |
| Lifting of seating surface | A | A | A | A | A | A | A | A | A |
| Coating condition of Conductor leading end | A+ | A+ | A+ | A+ | A+ | A+ | A+ | A+ | A |

TABLE 2

| Sample Number | | | B1 | B2 | B3 | B4 |
|---|---|---|---|---|---|---|
| Terminal | Height of level difference d [mm] | | 2.50 | | | |
| fitting | Length of flat portion L [mm] | | 10.0 | | | |
| | Single/Co-crimping | | Single | Co-crimp | Single | Co-crimp |
| Wire | Nominal conductor | Wire 1 | 5.00 | 2.00 | 8.00 | 5.00 |
| | cross-sectional area | Wire 2 | — | 2.00 | — | 1.25 |
| | (mm²) | | | | | |

| | | | | |
|---|---|---|---|---|
| Heat-shrinkable tube | SA3-2 | SA3-2 | SA3-3 | SA3-3 |
| Lifting of seating surface | B | B | B | B |
| Coating condition of Conductor leading end | A+ | A+ | A+ | A+ |

According to Tables 1 and 2, in the samples A1 to A9 that each had a level difference height of 2.88 mm or more, the seating surfaces did not lift up (A), whereas in the samples B1 to B4 that each had a level difference height of less than 2.88 mm, the seat surface lifted up (B). From this, it can be seen that due to a level difference having a height of 2.88 mm or more being provided in the terminal fitting, it is possible to suppress the seating surface from lifting up due to hanging down of the water blocking agent.

The samples A1 to A9 include the case in which a wire is crimped in a single-wire state and the case in which a plurality of wires are co-crimped. In either case, the seating surface can be prevented from lifting up. Furthermore, in the samples A1 to A9, in the case in which the nominal conductor cross-sectional area (in case of co-crimping, the sum value of those of the two conductors) is 5 mm² or less, SA3-2 with a small adhesive amount was used as the heat-shrinkable tube with a water blocking agent. In the case in which the nominal conductor cross-sectional area is larger than 5 mm², SA3-3 with a large adhesive amount was used. In either case, the seating surface did not lift up.

Furthermore, paying attention to the coating condition of the leading end portion of the conductor, in the samples A1 to A8 in which the length of the flat portion was 10 mm, the leading end portion of the wire conductor is completely covered with the water blocking layer and the coating layer (A+), whereas in the sample A9 in which the length of the flat portion was less than 10 mm, the leading end of the wire conductor is flush with the coating layer and is covered with the water blocking layer (A). From this, it can be seen that by setting the length of the flat portion, that is, the distance between the crimped portion and the level difference to 10 mm or more, the leading end portion of the wire conductor can be covered with the water blocking layer and the coating layer with a margin.

As described above, the embodiments of the present invention have been described in detail, but the present invention is not in any way limited to the above embodiments, and various modifications can be made without departing from the spirit of the present invention.

### LIST OF REFERENCE NUMERALS

1 Ground terminal
2 Wire harness
5 Heat shrinkable tube with water blocking agent
10, 10′ Terminal fitting
11 Crimping portion
11a Bottom surface
12 First crimping portion
12a First crimping piece
13 Second crimping portion
13a Second crimping piece
14 Inclined portion
15 Fastening portion
15a Through hole
16 Flat potion
17 Rotation-stopper
20 Water blocking layer
21 Extruded portion
22 Hanging portion
30 Coating layer
40 Wire
41 Conductor
41a Welding portion
42 Insulating coating
51 Heat shrinkable tube
52 Inner layer
D Height of level difference
L Length of flat portion
W Width of terminal fitting

1. A ground terminal comprising:
a terminal fitting having a crimping portion for crimping and fixing a wire and a fastening portion to be connected to a ground surface by a fastening member, and in which a level difference having a height of at least 2.88 mm and at most 7.0 mm is provided between the crimping portion and the fastening portion,
wherein a coating layer that is formed by a heat shrinkable tube being heat shrunk, and a water blocking layer that is formed by a water blocking agent for water-blocking the wire and arranged in a region including an inner circumferential portion of the coating layer are provided to cover at least the crimping portion of the terminal fitting, and
when an opposite direction to a direction in which the wire is mounted with respect to a bottom surface of the terminal fitting is taken as downward, and a direction in which the wire is connected to the terminal fitting is taken as rearward,
the level difference is provided such that the fastening portion is located on the lower side with respect to the crimping portion,
the coating layer is arranged on the rear side with respect to the level difference and located on an upper side with respect to the height position of the lower surface of the fastening portion, and
the water blocking agent does not remain only within a region covered by the coating layer and is partially extruded outside of the coating layer.

2. The ground terminal according to claim 1,
wherein a flat portion that has a length of 10 mm or more is provided between the crimping portion and the level difference, and
the water blocking layer and the coating layer cover a region rearward of an intermediate portion of the flat portion.

3. The ground terminal according to claim 1,
wherein the amount of the water blocking agent is, in a thickness in a state of being housed in the inner circumferential portion of the coating layer, at least 0.5 mm and at most 1.5 mm.

4. The ground terminal according to claim 1,
wherein the heat shrinkable tube contains cross-linked polyolefin.

5. The ground terminal according to claim 1,
wherein the coating layer is formed by the heat shrinkable tube being heat shrunk at a shrinkage ratio of at least 1% and at most 30%.

6. The ground terminal according to claim 1,
wherein the width of the terminal fitting where the crimping portion and the fastening portion intersect each other in a direction of being continuous with each other via the level difference is at least 5.0 mm and at most 9.0 mm.

7. The ground terminal according to claim 1,
wherein a conductor cross sectional area of the wire is at least 2 mm² and at most 20 mm² in a nominal conductor cross sectional area.

8. The ground terminal according to claim 1,
wherein the thickness of a metal material constituting the terminal fitting is at least 0.5 mm and at most 3.0 mm.

9. The ground terminal according to claim 1,
wherein the water blocking agent is formed by a hotmelt adhesive.

10. The ground terminal according to claim 1,
wherein the terminal fitting is formed by a metal material including a tinned layer on the surface thereof.

11. The ground terminal according to claim 1,
wherein the terminal fitting is provided with only one fastening portion.

12. The ground terminal according to claim 1,
wherein the ground terminal is used in an automobile.

13. The ground terminal according to claim 1,
wherein the ground terminal is used without stacking the fastening portions of a plurality of the ground terminals.

14. The ground terminal according to claim 1,
wherein the water blocking agent forms a hanging portion in at least one of a form of having solidified in a droplet shape below the flat portion provided between the crimping portion and the level difference of the terminal fitting or below the coating layer, or a form of having solidified in a state of flowing forward along a lower side surface of an inclined portion that connects between the flat portion and the fastening portion of the terminal fitting, and the hanging portion does not reach the height portion of the lower surface of the fastening portion.

15. The ground terminal according to claim 1,
wherein water blocking agent extruded from the coating layer forms an extruded portion on an upper front side of the crimping portion.

16. The ground terminal according to claim 1,
wherein the water blocking layer and the coating layer cover a region that spans from forward of the leading end of the conductor to rearward of the crimping portion of the terminal fitting.

17. The ground terminal according to claim 1,
wherein the lower surface of the fastening portion comes in planar contact with the ground surface formed in a plate shape when the fastening portion of the terminal fitting is fastened and fixed to the ground surface.

18. A wire harness comprising:
the ground terminal according to claim 1; and
a wire,
wherein an end portion of the wire is crimped and fixed by the crimping portion of the ground terminal and covered with the water blocking layer.

19. The wire harness according to claim 18,
wherein the wire is in a single-wire state, or a plurality of the wires are crimped by the crimping portion which is common thereto.
